(19) United States
(12) Patent Application Publication
(10) Pub. No.: US 2024/0275311 A1
(43) Pub. Date: Aug. 15, 2024

(54) ELECTROMECHANICAL DRIVE WITH FLAT REINFORCEMENT BODY

(71) Applicant: PHYSIK INSTRUMENTE (PI) GMBH & CO. KG, Karlsruhe (DE)

(72) Inventor: Reinhard HÜBNER, Waldbronn (DE)

(21) Appl. No.: 18/566,880

(22) PCT Filed: Jun. 24, 2022
(86) PCT No.: PCT/EP2022/067396

§ 371 Date: Dec. 4, 2023

(30) Foreign Application Priority Data
Jun. 24, 2021 (DE) 10 2021 116 325.0

(51) Int. Cl. H02N 2/04; H02N 2/02

(52) U.S. Cl. CPC H02N 2/04; H02N 2/025

(57) ABSTRACT

An electromechanical drive is provided comprising two units which can be moved relative to each other. By specifying the positioning movement of a unit and eliminating or at least mitigating the influence of a parasitic movement component on the function of the drive, the functionality of the drive can be ensured. This is achieved in that the electromechanical drive comprises a coupling element which has a flat reinforcement body and at least two connection sections which are attached to the reinforcement body in an articulated manner, wherein at least one of the connection sections is coupled to one of the units.

### CROSS REFERENCE TO RELATED APPLICATIONS

This application is a U.S. National Phase Application under 35 U.S.C. 371 of International Application No. PCT/EP2022/067396, filed on Jun. 24, 2022, which claims priority to German Patent Application No. 10 2021 116 325.0, filed on Jun. 24, 2021. The entire disclosures of the above applications are expressly incorporated by reference herein.

### BACKGROUND

### Technical Field

The present invention relates to an electromechanical drive with two units which can be moved relative to each other.

### Related Art

Such electromechanical drives, in which, for example, a rotor moves relative to a stator, are known. With these drives, the aim is basically to transmit a drive motion to the rotor or to an element to be driven connected to the rotor so that the rotor or the element to be driven, respectively, carries out a defined positioning motion along a direction of motion. However, in particular with electromechanical stick-slip or stick-slide or inertia drives and the jerky motions associated with them, there is the problem that parasitic motion components that act upon the rotor or the element to be driven, respectively, and correspond to no desired motion component along the direction of motion can have a significant influence on the operation of the drive, ranging from the loss of precision in the positioning motion to complete blockage of the drive.

The object of the present invention is therefore to provide an electromechanical drive which is able to specify the positioning motion of the rotor or an element to be driven and at the same time to eliminate or at least mitigate the influence of a parasitic motion component upon the operation of the drive and thus ensure the operationality of the drive.

### SUMMARY

This object is satisfied by an electromechanical drive with two units which can be moved relative to each other. According to the invention, the electromechanical drive comprises a coupling element which has a flat reinforcement body and at least two connection sections which are attached to the reinforcement body in an articulated manner, where at least one of the connection sections is coupled to one of the units.

In the electromechanical drive according to the invention, the coupling element can be used due to the flat reinforcement body and the connection sections being attached in an articulated manner such that it always allows for the desired motion components required for driving the rotor or the element to be driven and eliminates or at least mitigates the influence of parasitic motion components upon the operation of the drive.

It can be useful to have the coupling element be firmly connected to at least one of the units. This makes it possible to transfer motions from this unit to the coupling element or from the coupling element to this unit in a very rigid manner.

It can be useful to have at least one other of the connection sections be coupled to the other of the units or be coupled to an element to be driven. As a result, one unit can be positioned uniquely relative to the other unit or the drive motion can be transferred to an element to be driven, respectively.

It can be advantageous to have the units be movable relative to each other along a direction of motion and the flat reinforcement body extend in a plane parallel or perpendicular to the direction of motion. When the flat reinforcement body extends in a plane parallel to the direction of motion, the desired motion components can be optimally transmitted. When the flat reinforcement body extends in a plane perpendicular to the direction of motion, parasitic motion components can be blocked as best as possible and their influence can thus be eliminated or mitigated, respectively.

It can be practical to have the connection sections, and preferably the entire coupling element, extend in the same plane as the flat reinforcement body. Once the connection sections are attached to the flat reinforcement body in an articulated manner and extend in the same plane as the flat reinforcement body, a high shear rigidity and a low flexural rigidity of the coupling element in the plane of extension can be obtained.

It can be useful to have each connection section be attached to the flat reinforcement body by way of at least one flexure hinge. With the aid of the flexure hinges, a simple, robust, and at the same time elastic attachment of the connection sections to the flat reinforcement body is possible.

It can prove to be advantageous to have the flat reinforcement body be configured to be ring-shaped. Due to the ring-shaped structure, a high level of rigidity (shear rigidity) can be obtained in the plane of extension of the flat reinforcement body. This also enables a homogeneous flow of force, which prevents stress peaks in the flat reinforcement body.

Preferably, the flat reinforcement body has a larger material cross section along the entire ring shape than a flexure hinge with which a connection section is attached to the reinforcement body.

It can be useful to have the connection sections be arranged within or outside the flat reinforcement body. As a result, the coupling element can be adapted to the external conditions, in particular the available installation space.

It can prove to be practical to have the connection sections be arranged mirror-symmetrically with respect to a central axis of the flat reinforcement body, preferably double-mirror-symmetrically with respect to two central axes, particularly preferably double-mirror-symmetrically with respect to two central axes intersecting at a right angle, where the central axis or the central axes extend in the plane of the flat reinforcement body. Due to the mirror-symmetrical configuration of the coupling element, motion components acting in opposite directions can be transmitted or attenuated equally well.

It can be useful to have the coupling element comprise four connection sections, two of which represent first connection sections that are coupled to one of the units, and two second connection sections that are coupled to the other of the units or can be coupled to an element to be driven. Due to the fact that two connection sections are always coupled to a unit, a stable and anti-rotation attachment of the coupling element to the units or to the element to be driven can be created.

It can be advantageous to have a line connecting the first connection sections and a line connecting the second connection sections run parallel to each other or intersect at a right angle. A section of the flat reinforcement body is therefore disposed between the force introduction points and the force exit points, whereby the shear rigidity of the coupling element is increased.

It can prove to be useful to have each connection section comprise an opening, preferably in a circular shape, particularly preferably with a circumferential web, for coupling to one of the units or an element to be driven, preferably by way of a screw. This makes it possible to create a simple and inexpensive attachment of the coupling element to the units or the element to be driven, respectively.

It can be practical to have the connection sections be arranged in tabs integrally connected to the flat reinforcement body and flexure hinges be formed by recesses in the tabs. This allows the coupling element to be produced in a simple manner from coherent material.

It can be advantageous to have the coupling element be a one-piece flat metal sheet or be composed of several flat metal sheets. This makes it possible to produce the coupling element in an inexpensive and simple manner, for example, by punching it out.

It can be advantageous to have the units, which can be moved relative to each other, be formed by a stator and a rotor, where the rotor is movable relative to the stator, preferably by way of one or more guide elements.

### BRIEF DESCRIPTION OF THE DRAWINGS

FIG. 1 a to FIG. 1c show various perspective views and a top view of a drive according to the invention in a first embodiment.

FIGS. 2a and 2b show a top view and a perspective view of a coupling element, which is part of the drive according to the first embodiment.

FIG. 3a and FIG. 3b show various views of a drive according to the invention of a second embodiment.

FIGS. 4a and 4b show a perspective view and a top view of the drive according to the second embodiment, where the rotor of the drive is not shown for reasons of illustration.

FIG. 5 shows a top view of a coupling element which is part of the drive according to the second embodiment.

### DETAILED DESCRIPTION

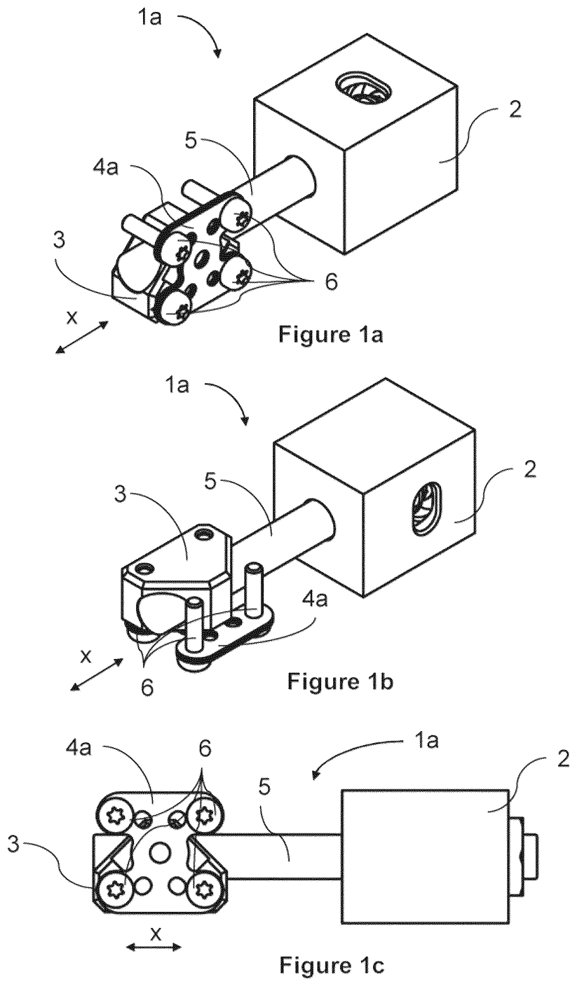

FIG. 1a to FIG. 1c show a first embodiment of an electromechanical drive 1a according to the invention. Electromechanical drive 1 a comprises a stator 2 and a rotor 3 which are configured as units which can be moved relative to each other. Rotor 3 can be moved relative to stator 2 using a guide element 5. Electromechanical drive 1 a can be, for example, a stick-slip drive, in which guide element 5 is firmly connected to an electromechanical actuator housed in stator 2, e.g. a piezo actuator, and rotor 3 is in stick-slip contact with guide element 5. Due to the motions transmitted from the electromechanical actuator to guide element 5 and the inertia of rotor 3, rotor 3 can be moved in a direction of motion x along guide element 5. In addition to a stick-slip drive, electromechanical drive 1 a can also be a standing wave motor in which an electromechanical actuator housed in stator 2 comprises one or more friction elements which, when the actuator is suitably excited, carry out a defined, preferably elliptical, oscillatory motion and thus drive guide element 5. In this case, rotor 3 is firmly connected to guide element 5 and moves together with guide element 5 in direction of motion x relative to stator 2. Further functional principles of electromechanical drive 1a are conceivable beyond that. As an example, reference is presently made to the possibility of a stepping motor.

In the present embodiment, guide element 5 is configured to be rod-shaped. Rotor 3 comprises an opening which is configured to be complementary to the rod shape of guide element 5 and through which guide element 5 protrudes. This means that rotor 3 is formed at least in sections by a type of sleeve which is in contact with guide element 5. Furthermore, rotor 3 comprises an attachment section to which a coupling element 4a can be attached. In the present case, coupling element 4a is approximately a thin H-shaped plate which is coupled at one of its legs to rotor 3 and at the other leg can be coupled to an element to be driven, not shown. Coupling element 4a is coupled to rotor 3 such that the legs are aligned parallel to direction of motion x.

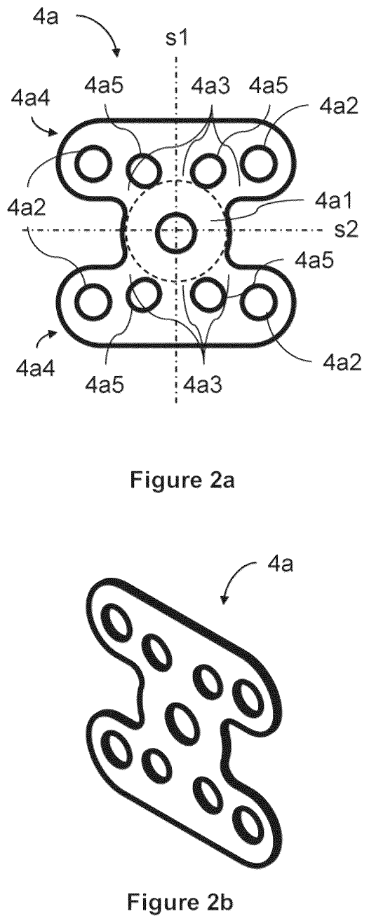

Coupling element 4a shall be described in more detail below with reference to FIGS. 2a and 2b. Coupling element 4a in the form of an H-shaped plate substantially comprises a ring-shaped flat reinforcement body 4a1 (indicated by the dashed circle) and two tabs 4a4 integrally connected thereto, which correspond to the legs of the H-shaped plate. Flat reinforcement body 4a1 therefore represents a connection point for the legs. Two connection sections 4a2 are formed in the shape of openings in each of tabs 4a4. Connection sections 4a2 of a tab 4a4 are coupled, preferably by way of screws 6, to rotor 3, connection sections 4a2 of other tab 4a4 can be coupled, preferably by way of screws 6, to the element to be driven, not shown. In the present case, the openings forming connection sections 4a2 and the opening provided in ring-shaped flat reinforcement body 4a1 have approximately the same diameter.

In particular, connection sections 4a2 are connected by way of flexure hinges 4a3 to flat reinforcement body 4a1. Flexure hinges 4a3 are there formed by recesses 4a5 in tabs 4a4 as well as by incisions along the outer contour of coupling element 4a (incisions between the legs). As a result, connection sections 4a2 are attached in an articulated manner to flat reinforcement body 4a1. As visibly shown in FIG. 2a, flat reinforcement body 4a1 has a larger material cross-section along the entire ring shape than each of flexure hinges 4a3 with which connection sections 4a2 are attached to reinforcement body 4a1 (the ring wall thickness of the ring shape is greater than the width of each of flexure hinges 4a3).

Furthermore, entire coupling element 4a is configured to be mirror-symmetrical to a central axis s1 and to a central axis s2 arranged perpendicular thereto. Coupling element 4a can preferably consist of a one-piece metal sheet or alternatively of several metal sheets assembled.

During operation, the forces from rotor 3 are introduced into coupling element 4a via two connection sections 4a2 of a tab 4a4 (of a leg) and are passed via the ring-shaped structure of flat reinforcement body 4a1 to connection sections 4a2 of second tab 4a4 (of the second leg) and from there transferred to the element to be driven. Since ring-shaped flat reinforcement body 4a1 and connection sections 4a2 extend in the same plane, a high shear rigidity is obtained in this plane. As a result, the desired motion component of rotor 3, which acts in direction of motion x, can be transmitted as rigidly as possible to the element to be driven, which improves the precision of the positioning motion. On the other hand, forces that act upon connection sections 4a2 perpendicular to the plane of extension of coupling element 4a are absorbed by bending open or bending down connection sections 4a2 due to the articulated and, in this load case, flexurally soft attachment of connection sections 4a2 to flat reinforcement body 4a1. This means that, due to the low flexural rigidity of coupling element 4a with respect to an axis disposed in the plane of coupling element 4a, the drive and the element to be driven can be decoupled with regard to parasitic motion components, which contributes significantly to fault-free and precise operation of the drive.

In other words, coupling element 4a is configured such that, when used as intended, it carries out no or only very slight deformations in its plane of extension and comparatively large deformations out of this plane or in a plane perpendicular thereto, respectively.

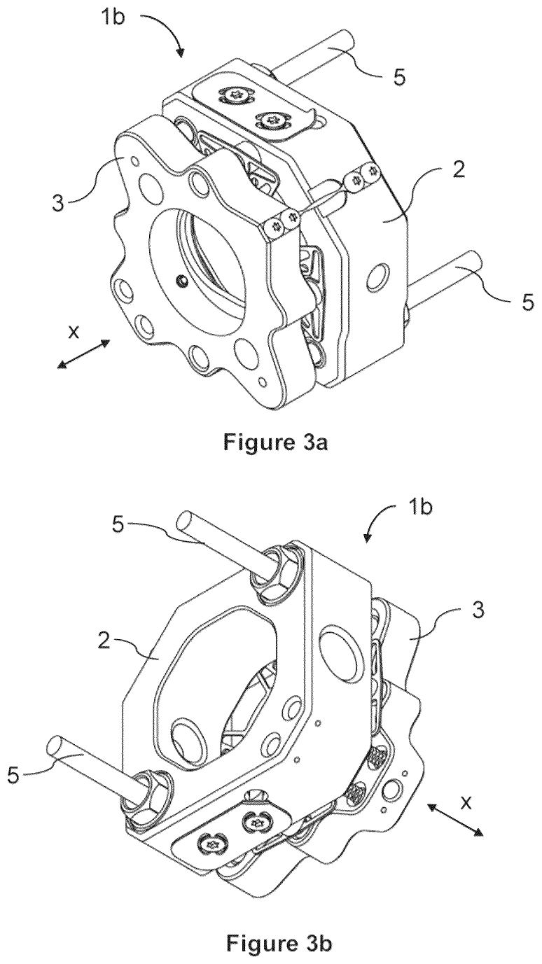

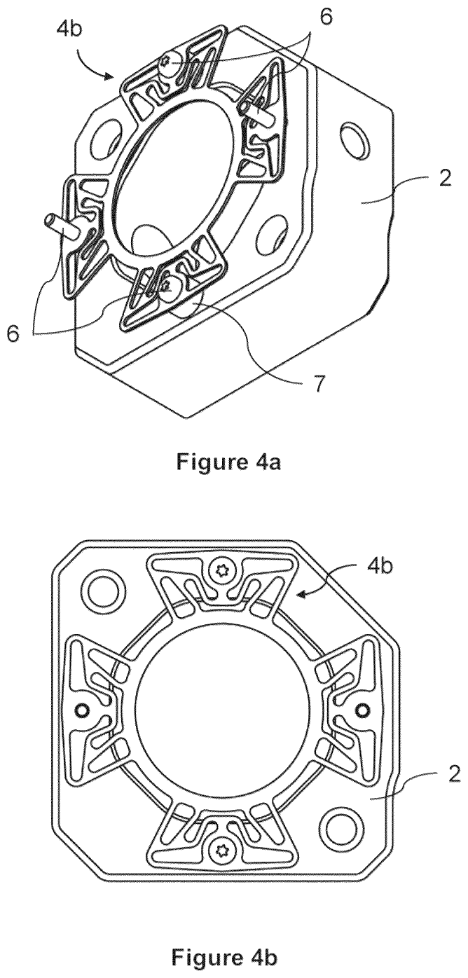

A second embodiment of an electromechanical drive 1b according to the invention is shown in FIGS. 3a and 3b. In analogy to the first embodiment, electromechanical drive 1b comprises units in the form of a stator 2 and a rotor 3 which can be moved relative to each other. In this case, rotor 3 is connected to the ends of two guide elements 5 which protrude through openings in stator 2 and are in engagement with electromechanical actuators housed in stator 2. Guide elements 5 are consequently driven by the actuators and move together with rotor 3 relative to stator 2 along direction of motion x. With respect to stator 1 or rotor 3, respectively, guide elements 5 are arranged to be disposed diametrically opposite one another. A coupling element 4b is connected to stator 2 as well as rotor 3. The attachment of coupling element 4b to stator 2 is illustrated again in FIGS. 4a and 4b. Rotor 3 is not shown in FIGS. 4a and 4b for purposes of illustration.

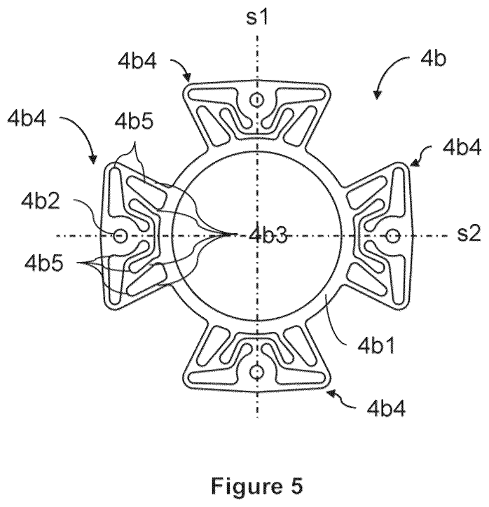

FIG. 5 shows coupling element 4b in detail. Coupling element 4b comprises a flat reinforcement body 4b1 and four tabs 4b4 integrally connected thereto. In each tab 4b4, a connection section 4b2 as well as flexure hinges 4b3 are provided for the articulated attachment of connection sections 4b2 to flat reinforcement body 4b1. In analogy to coupling element 4a, flexure hinges 4b3 are formed by recesses 4b5 and corresponding incisions between tabs 4b4. Coupling element 4b then comprises the same components as coupling element 4a previously described. The functions of the individual components of coupling element 4b also correspond to the functions of the components of coupling element 4a. Coupling element 4b therefore only differs from coupling element 4a in the arrangement and the specific configuration as well as the sizes of the individual components. In particular, the diameter of the opening formed in the ring-shaped flat reinforcement body 4b1 is a multiple, preferably at least ten times that, of the respective diameter of the openings formed in connection sections 4b2. In this embodiment as well, flat reinforcement body 4b1, as can be seen in FIG. 5, has a larger material cross-section along the entire ring shape than each of flexure hinges 4b3 with which connection sections 4b2 are attached to reinforcement body 4b1 (the ring wall thickness of the ring shape is greater than the width of each of flexure hinges 4b3).

It can be gathered from FIGS. 3 and 4 that connection sections 4b2, which are provided in tabs 4b4 that are disposed oppositely with respect to flat reinforcement body 4b1, are connected to the same unit. This means that, in the event that connection sections 4b2 arranged along central axis s1 are connected to stator 2, connection sections 4b2 arranged along central axis s2 are connected to rotor 3. Since coupling element 4b is configured to be mirror-symmetrical to central axis s1 and to central axis s2, connection sections 4b2 arranged along central axis s2 can also be connected to stator 2 and connection sections 4b2 arranged along central axis s1 can be connected to rotor 3.

Connection sections 4b2 are preferably connected to stator 2 or rotor 3 by way of screws 6, where spacer rings 7 are provided between each connection section 4b2 and the corresponding abutment side of stator 2 and rotor 3. As a result, coupling element 4b does not rest flat on the abutment side of stator 2 or rotor 3, respectively, but is arranged spaced from these abutment sides.

As already mentioned above, rotor 3 is driven by two guide elements 5 disposed diametrically opposite which protrude through openings in stator 2 and move relative thereto. In order to prevent electromechanical drive 1b from jamming, it is necessary that guide elements 5, in particular their longitudinal axes, are always aligned at the same distance from one another and exactly congruent with the longitudinal axes of the openings in stator 2. With the aid of coupling element 4b, which is connected to stator 2 as well as to rotor 3, forces that act upon rotor 3 perpendicular to direction of motion x can be diverted directly into stator 2 so that the position and attitude of rotor 3 and guide elements 5 are not influenced by these forces. This means that a parasitic motion component of rotor 3 arising perpendicular to direction of motion x is blocked in its plane of extension due to the high shear rigidity of coupling element 4b so that rotor 3 can be precisely centered relative to stator 2 in a plane perpendicular to direction of motion x, which contributes significantly to a fault-free drive and prevents guide elements 5 from jamming in relation to stator 2.

On the other hand, forces that act in direction of motion x upon connection sections 4b2 of coupling element 4b are absorbed by bending open or bending down connection sections 4b2 due to the articulated and, in this load case, flexurally soft connection of connection sections 4b2 to flat reinforcement body 4b1. This means that, due to the low flexural rigidity of coupling element 4b with respect to an axis disposed in the plane of coupling element 4b, coupling element 4b allows for a desired motion component of rotor 3 acting in direction of motion x so that rotor 3 can be moved relative to stator 2. The possible adjustment travel of rotor 3 there depends on the elastic flexural deformation capacity of coupling element 4b.

In analogy to coupling element 4a, coupling element 4b is therefore configured such that, when used as intended, it carries out no or only very slight deformations in its plane of extension and comparatively large deformations out of this plane or in a plane perpendicular thereto.

Furthermore, coupling element 4b can also consist of a one-piece metal sheet or of several metal sheets assembled.

The above explanations describe two coupling elements 4a, 4b, in which connection sections 4a2, 4b2 or tabs 4a4, 4b4 having connection sections 4a2, 4b2 are arranged outside the ring-shaped flat reinforcement body 4a1, 4b1. However, it is also conceivable that connection sections 4a2, 4b2 are arranged within the ring-shaped flat reinforcement body, for example, in order to meet respective installation space requirements. In addition, still other dimensions of flat reinforcement body 4a1, 4b1 and connection sections 4a2, 4b2 or tabs 4a4, 4b4, respectively, can then be realized, as a result of which the respective rigidities of coupling element 4a, 4b can be adapted depending on the case of application.

1-15. (canceled)

16. An electromechanical drive comprising:
two units which are movable relative to each other; and
a coupling element which has:
a flat reinforcement body; and
at least two connection sections which are attached to said reinforcement body in an articulated manner,
wherein at least one of said connection sections is coupled to one of said units and at least one other of said connection sections is coupled to the other of said units or configured to be coupled to an element to be driven.

17. The electromechanical drive according to claim 16, wherein said coupling element is firmly connected to at least one of said units.

18. The electromechanical drive according to claim 16, wherein said units are movable relative to each other along a direction of motion and said flat reinforcement body extends in a plane parallel or perpendicular to said direction of motion.

19. The electromechanical drive according to claim 16, wherein at least said connection sections of said coupling element extend in the same plane as said flat reinforcement body.

20. The electromechanical drive according to claim 16, wherein each connection section is attached to said flat reinforcement body by at least one flexure hinge.

21. The electromechanical drive according to claim 16, wherein said flat reinforcement body is ring-shaped.

22. The electromechanical drive according to claim 16, wherein said connection sections are arranged within or outside said flat reinforcement body.

23. The electromechanical drive according to claim 16, wherein said connection sections are mirror-symmetrical with respect to a central axis of said flat reinforcement body, where said central axis extends in the plane of said flat reinforcement body.

24. The electromechanical drive according to claim 16, wherein said coupling element comprises four connection sections including two first connection sections and two second connection sections, the first connection sections being coupled to one of said units, the two second connection sections being coupled to the other of said units or configured to be coupled to the element to be driven.

25. The electromechanical drive according to claim 24, wherein a line connecting said first connection sections and a line connecting said second connection sections run parallel to each other or intersect at a right angle.

26. The electromechanical drive according to claim 16, wherein each connection section comprises an opening for coupling to one of said units or to the element to be driven.

27. The electromechanical drive according to claim 16, wherein said connection sections are arranged in tabs which are integrally connected to said flat reinforcement body, and flexure hinges are formed by recesses in said tabs.

28. The electromechanical drive according to claim 16, wherein said coupling element is a one-piece flat metal sheet or is composed of several assembled flat metal sheets.

29. The electromechanical drive according to claim 16, wherein said two units comprise a stator and a rotor, wherein said rotor is movable relative to said stator by way of one or more guide elements.

30. The electromechanical drive according to claim 16, wherein said connection sections are double mirror-symmetrical with respect to two central axes, where said two central axes extend in the plane of said flat reinforcement body.

31. The electromechanical drive according to claim 16, wherein said connection sections are double mirror symmetrical with respect to two central axes intersecting at a right angle, where said central axes extend in the plane of said flat reinforcement body.

32. The electromechanical drive according to claim 16, wherein each connection section comprises an opening in a circular shape for coupling to one of said units or to the element to be driven.

33. The electromechanical drive according to claim 16, wherein each connection section comprises an opening in a circular shape with a circumferential web for coupling to one of said units or to the element to be driven.
